(19) United States
(12) Patent Application Publication
(10) Pub. No.: US 2006/0162513 A1
(43) Pub. Date: Jul. 27, 2006

(54) Trimmer with light guidance

(75) Inventors: Colin Knight, Skokie, IL (US); Janne Hansen, Winchester (GB)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: General Binding Corporation, Northbrook, IL (US)

(21) Appl. No.: 11/122,141

(22) Filed: May 4, 2005

Related U.S. Application Data
(60) Provisional application No. 60/646,030, filed on Jan. 21, 2005.

(51) Int. Cl. B26D 1/00

(52) U.S. Cl. 83/13

(57) ABSTRACT

The invention provides a cutting apparatus for cutting sheet material comprising a base with an upper surface having an edge, a non-circular cutting blade, and a light emitting device. The cutting blade is pivotably coupled to the base portion. The blade may be lowered to cut a sheet material disposed at least partially on the upper surface and extending at least partially off of the upper surface along the edge. The light emitting device is preferably a laser disposed above the base portion. When the sheet material is placed on the upper surface of the base, the light emitting device projects the line of light onto the top surface of the sheet material to provide a visual indication of the location of the sheet material relative to the edge prior to cutting the sheet material with the blade. A method for cutting sheet material utilizing the device is also provided.

### CROSS-REFERENCE TO RELATED APPLICATIONS

This patent application claims the benefit of U.S. Provisional Patent Application No. 60/646,030, filed Jan. 21, 2005.

### FIELD OF THE INVENTION

This invention pertains to trimmers for cutting sheet material, and, more particularly, sheet trimmers that include visual guidance for sheet placement and cutting.

### BACKGROUND OF THE INVENTION

Trimmers for cutting sheet material usually include a base to place a sheet material upon and a cutting apparatus to cut the sheet material. In the case of so-called guillotine trimmers, the cutting apparatus includes an elongated blade pivotably coupled to the base at one end such that the blade slices along the edge of the base to cut sheets disposed on and extending over the edge of the base. To cut at the desired position, a user is typically forced to eyeball the location of the sheet material relative to the portions of the cutting edge that are visible on one or both sides of the overhanging sheet material. This often results in cuts that are misaligned, particularly if the image to be cut is spaced in from the edge of the sheet material. To improve cutting accuracy, a user could draw a line extending the length of the sheet material such that the line at the opposed edges of the sheet may be lined up with the edge of the trimmer base. Such particularized marking is time consuming, however, and results in sometimes undesirable marks on the sheet material itself. Some trimmers additionally or alternately include grids and/or rule markings on the base to assist the user in positioning a piece of sheet material and cut at the desired location. Although such grids and rulers may be helpful for a user when cutting a spaced distance from an edge of the sheet material, such arrangements are of little help to a user seeking to trim relative to an interior reference point on the sheet material. A grid is also unhelpful when the sheet material is large enough to cover all or substantially all of the grid.

### BRIEF SUMMARY OF THE INVENTION

The invention provides a cutting apparatus and method to provide a visual indication of the location of a sheet material relative to the cutting edge, thus allowing a user to make precise cuts at desired positions. More particularly, the invention provides a cutting apparatus comprising a base with an upper surface having an edge, a non-rotary or non-circular cutting blade pivotably coupled to the base portion and selectively moveable to cut a sheet disposed upon the upper surface and extending over the edge of the base, and a light emitting device disposed above the base portion to project a line of light onto the top surface of the sheet material. For the purposes of this disclosure, the terms non-rotary and non-circular are used to distinguish the cutting blade from a driven, rotating, circular blade. When the sheet material is placed on the upper surface of the base, the light emitting device projects the line of light onto the top surface of the sheet material to provide a visual indication of the location of the sheet material relative to the edge prior to cutting the sheet material with the blade. The blade itself is movable between a first position wherein the blade is at least partially separate from the edge to a second position wherein the blade is disposed at least partially adjacent to the edge, the blade being movable from the first position to the second position to cut the sheet material disposed at least partially on the upper surface and extending at least partially off of the upper surface along the edge.

The invention also provides a method of cutting sheet material disposed upon such a device. The method comprising, providing a cutting apparatus comprising a base and a non-rotary or non-circular cutting blade pivotably coupled to the base, the base comprising an upper surface having an edge, disposing the sheet material on the upper surface of the base with at least a portion of the sheet material extending beyond the edge, projecting a line of light onto a top surface of the sheet material to provide a visual indication of the location of the sheet material relative to the edge, and pivoting the blade toward the edge to cut the sheet material.

These and other advantages of the invention, as well as additional inventive features, will be apparent from the description of the invention provided herein.

### BRIEF DESCRIPTION OF THE DRAWINGS

FIG. 1 is a perspective view from above of a trimmer with laser guidance and constructed in accordance with teachings of the invention.

FIG. 2 is a perspective view from above of the trimmer of FIG. 1 with a safety shield.

FIG. 3 is a side elevational view of the trimmer of FIGS. 1 and 2 with the blade in the lowered position.

FIG. 4 is another perspective view from above of the trimmer of FIGS. 1-3.

FIG. 5 is a top plan view of the trimmer of FIGS. 1-4.

FIG. 6 is an exploded view showing the light emitting device of the trimmer of FIGS. 1-5.

FIG. 7 is another exploded view of the light emitting device of the trimmer of FIGS. 1-6.

FIG. 8 is a top plan view of the light emitting device of the trimmer of FIGS. 1-7.

FIG. 9 is a perspective view of the trimmer of FIGS. 1-8 with a sheet material disposed thereon and the light emitting device projecting a line of light onto a sheet material.

FIG. 10 is a perspective view of the trimmer of FIGS. 1-9 with a sheet material disposed thereon and the light emitting device projecting a line of light onto a sheet material at a position other than that shown in FIG. 9.

### DETAILED DESCRIPTION OF THE INVENTION

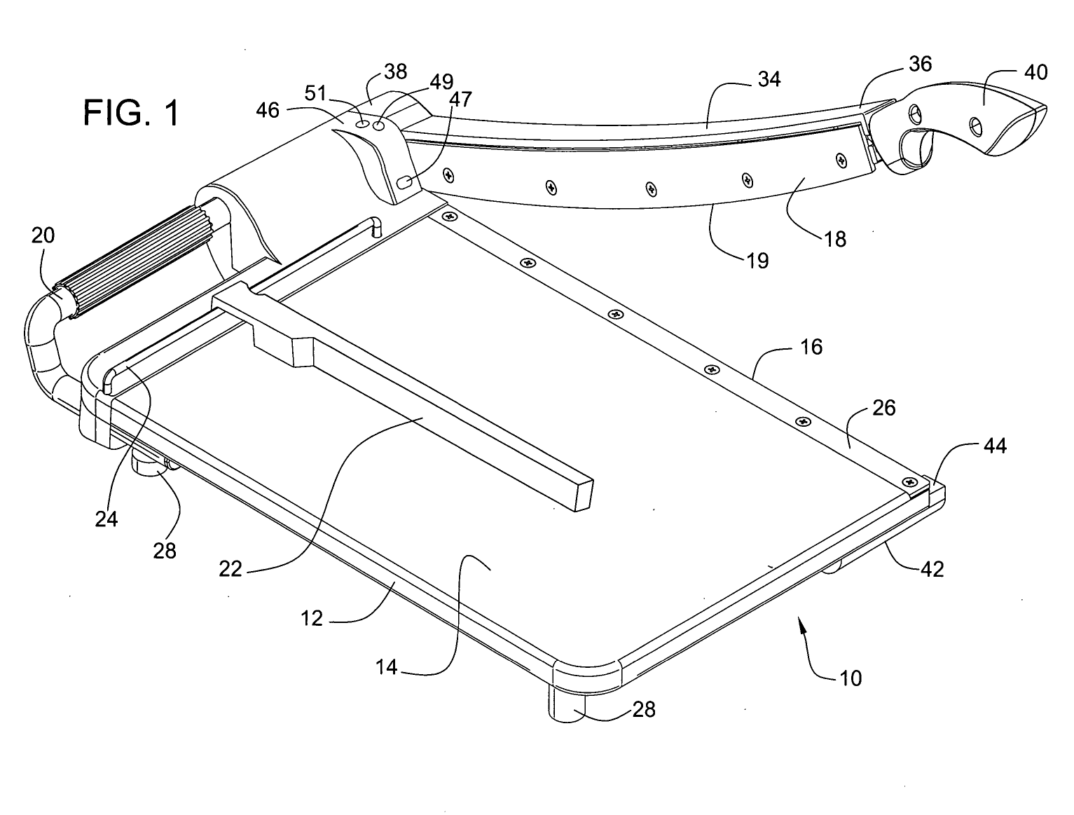

Turning now to the drawings, there is shown in FIG. 1, a cutting apparatus in the form of a trimmer 10 for cutting sheet material. The trimmer 10 has a base 12 with an upper surface 14 and a cutting edge 16. The base 12 is shown as generally quadrilateral shaped, although one of ordinary skill in the art would recognize that the base 12 could be any suitable shape as long as there is at least one portion of the base 12 able to accommodate the lowering of a cutting blade 18. The upper surface 14 of the base 12 is relatively flat for the placement of a sheet material 60 thereon.

As shown, the base 12 may be equipped with a base handle portion 20. The base handle portion 20 may be used to lift and move the trimmer 10. The base 12 may also have a movable crossbar 22, which may be used to help align a sheet material 60 on the upper surface 14 of the base 12. The movable crossbar 22 may alternately be used as a straight edge for marking the sheet material 60, and may also be used to help retain a sheet material 60 in place while the sheet material 60 is being cut. The crossbar 22 is slidably disposed along a rail 24 attached to the base 12. The crossbar 22 may be removable from the base 12 when not in use.

A grid may be displayed on the upper surface 14 of the base 12 to aid with the positioning of a sheet material 60. Alternately, or in addition to a grid, a measurement device such as a ruler may be disposed or depicted on the base 12. The base 12 may have a plate 26 disposed near the cutting edge 16 to provide a durable cutting edge 16. It is important that the cutting edge 16 be relatively resistant to wear such that even after frequent use, cuts continue to be precise. This plate 26, although not an essential component, is particularly useful when the base 12 is constructed of a less durable material, such as wood, for example. One of ordinary skill in the art will recognize that the plate 26, if included, may be any suitable shape or size.

Support members 28 may be disposed below the base 12 to support the base 12 above a surface upon which it rests. As shown, the base 12 has several cylindrical support members 28 attached to a bottom surface of the base 12. If support members 28 are provided, they could be any form suitable for supporting the base 12 above a surface upon which the base 12 is disposed.

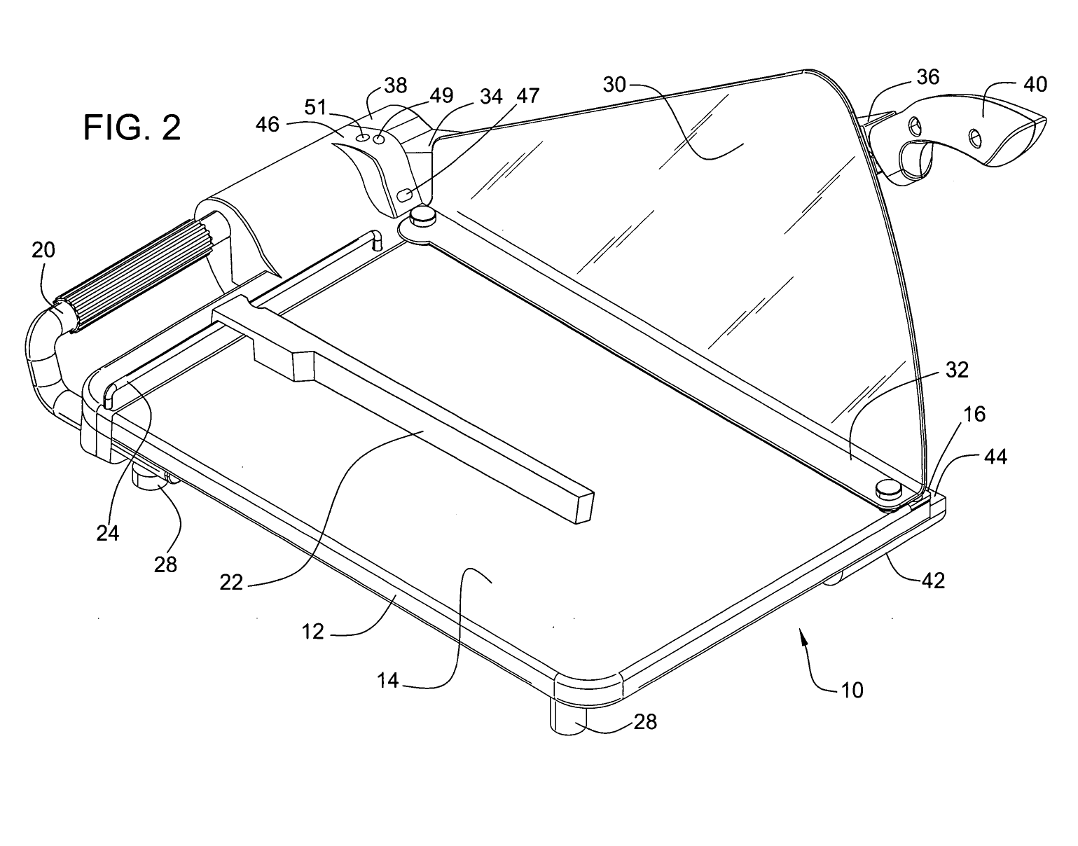

As shown in FIG. 2, the trimmer 10 may include a safety shield 30. The safety shield 30 is disposed near the cutting edge 16 and is attached to the base 12 such that there is sufficient clearance between the bottom portion 32 of the safety shield and the upper surface 14 of the base 12 for at least one sheet material 60. The safety shield 30 is preferably transparent such that the cutting edge 16 and the sheet material 60 are visible therethrough. While the safety shield 30 is preferably transparent, it could be constructed of any suitable material. The safety shield 30 may be adjustable such that once a user places a desired number of sheet materials 60 under the bottom portion of the safety shield 30, the safety shield 30 could be lowered to secure the sheet material 60 during cutting. The safety shield 30 provides a barrier between a user's fingers and the cutting blade 18, such that a user can advance the sheet material toward the cutting edge 16 without endangering the user's fingers.

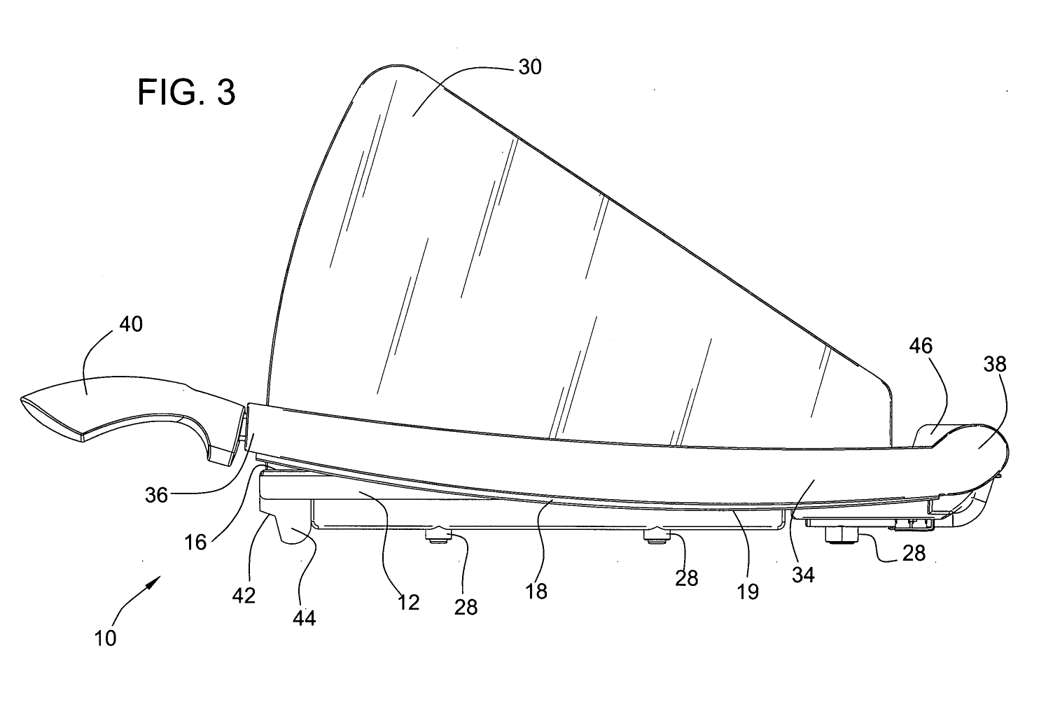

As shown in FIGS. 1-3, the trimmer 10 has a blade 18 for cutting sheet material 60 disposed on and extending over the cutting edge 16 of the upper surface 14 base 12. The blade 18 is attached to a blade support member 34 having a distal end 36 and a proximal end 38. Located at the distal end 36 is a handle 40 for a user to grasp when raising and lowering the blade 18. The blade support member 34 is pivotably coupled to the base 12 at the blade support member's proximal end 38 such that when the blade support member 34 is lowered, the blade 18 coupled thereto progressively crosses the plane of the upper surface 14 of the base 12 immediately adjacent the cutting edge 16 such that the blade 18 cuts sheet material 60 disposed on the upper surface 14 and extending over the cutting edge 16 of the base 12. When in use, a sheet material 60 is positioned while the blade 18 is raised above the upper surface 14 of the base 12. Once the sheet material is in the desired position, the user can grasp the handle 40 to pivot the blade 18 towards the cutting edge 16 and cut the sheet material 60. As described and shown in this figure, the blade 18 is attached to a blade support member 38. One of ordinary skill in the art would recognize, however, that the blade 18 and blade support member 38, including the handle 40, could be manufactured as either a single piece or multiple pieces. In addition, although the blade 18 is depicted as an elongate blade with an arcuate blade edge 19, one of ordinary skill in the art would recognize that the blade 18 may have an alternate construction.

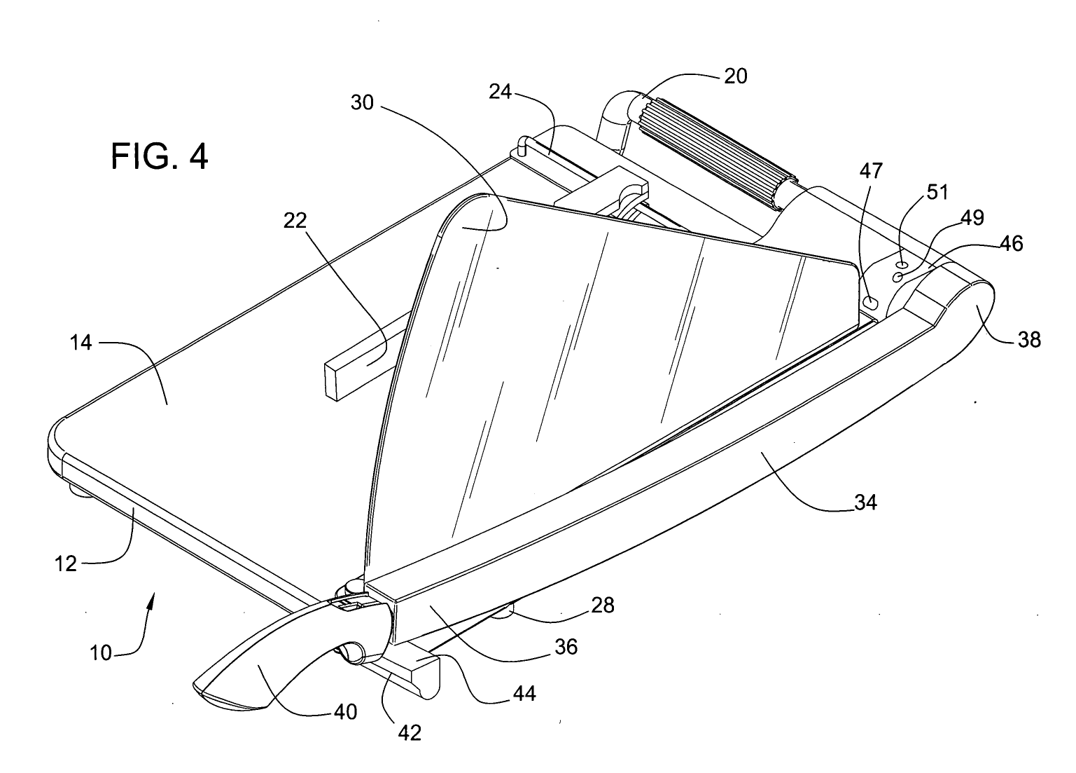

Referring to FIG. 4, the base 12 may also have a blade stop 42 on the side of the base 12 near the cutting edge 16 such that when the blade 18 is lowered, it will not pass beyond the blade stop 42. The blade stop 42 comprises an extension member 44 that extends beyond the side of the base 12 a sufficient distance such that as the blade 18 is lowered, it will eventually be prevented from further movement by the blade stop 42. This prevents potential injury to a user if the blade 18 were able to swing beyond the lowest extremity of the base 12 itself and also prevents damage to any underlying surface upon which the trimmer 10 might rest. The trimmer 10 may also be provided with a locking mechanism (not shown), such as a latch, to prevent the blade 18 from pivoting upward away from the base when the trimmer 10 is not in use. For both safety and storage purposes, the locking mechanism would preferably retain the blade 18 in the lowered position. One ordinary skill in the art would recognize that various shapes and types of the blade stop 42 and locking mechanism could be used.

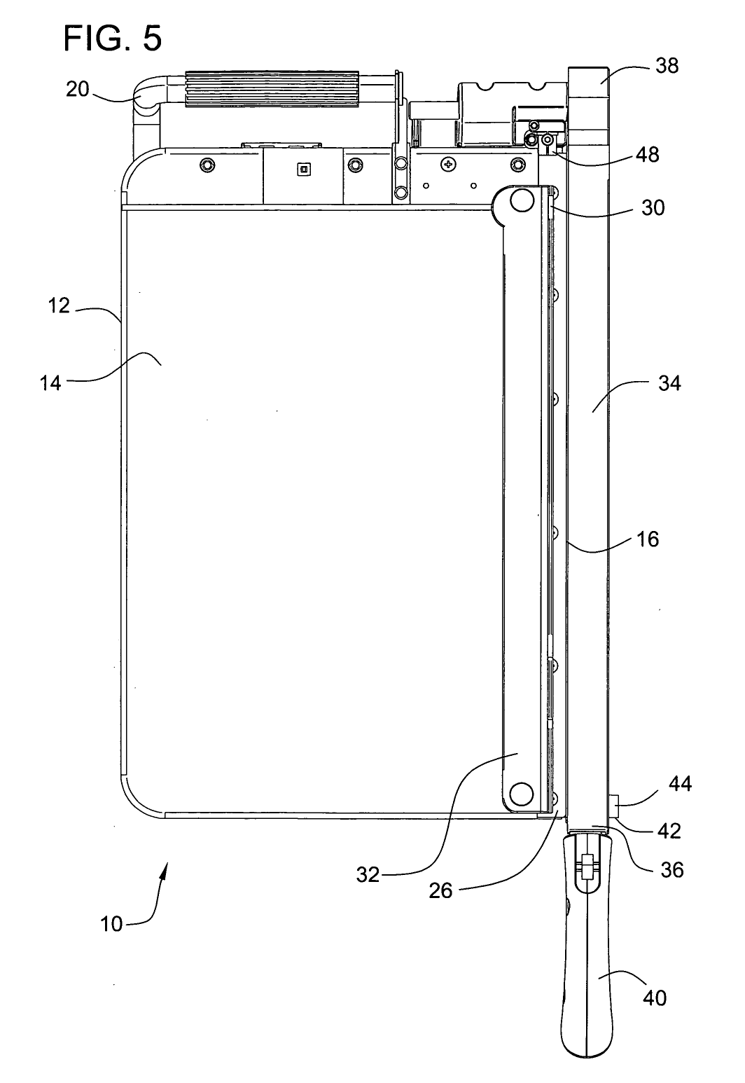

In accordance with the invention, the trimmer 10 includes a light emitting device 48 disposed to project a line of light preferably along the cutting edge 16. In this way, the light emitting device 48 provides the user with a visual indication of the cutting edge 16 when sheet material 60 is disposed along the base 12 and extending over the cutting edge 16 such that the user may visualize where a cut will be made upon lowering the blade 18. The light emitting device 48 may be disposed in any suitable location above the upper surface 14 of the base 12 such that it emits a line of light 58 onto a top surface of a sheet material to provide a visual indication of the sheet material relative to the cutting edge 16. In the illustrated embodiment, a cover 46 is provided at the pivot coupling of the blade support member 34, which likewise at least partially encloses the light emitting device 48. The cover 46 may have one or more openings, such as opening 47 to allow the line of light 58 to exit from inside the cover 46. In order to provide for user adjustment of the light emitting device 48 itself, as will be described in greater detail below, the cover 46 may include additional openings 49, 51. In FIG. 5, the cover 46 has been removed to reveal the light emitting device 48 for further explanation herein.

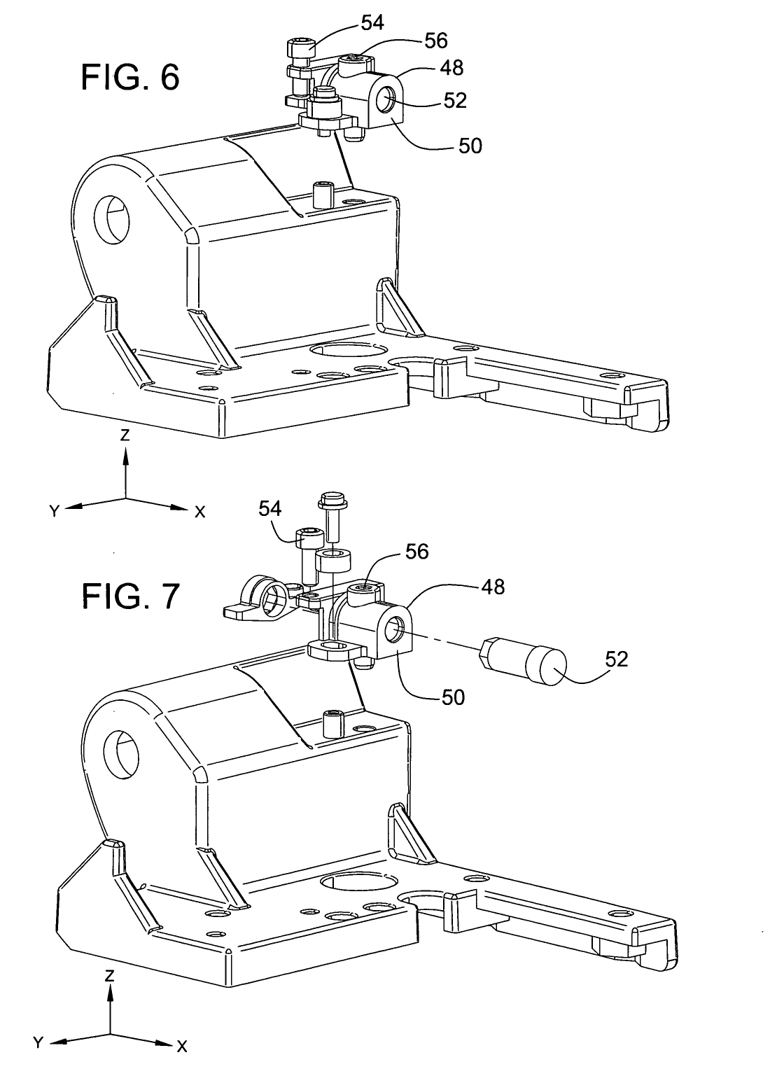

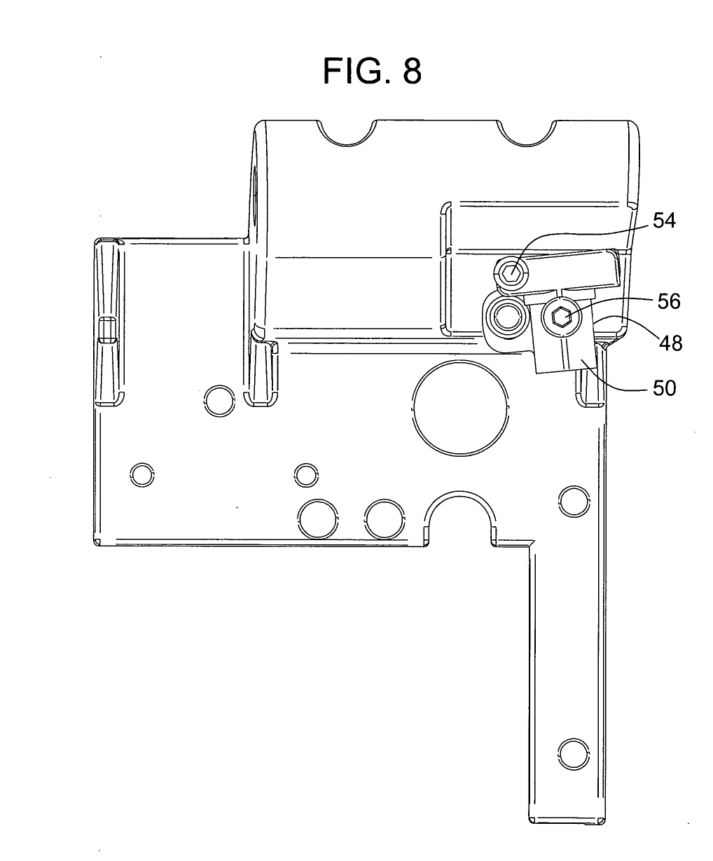

As shown in FIGS. 6 and 7, the light emitting device 48 generally comprises a housing 50 in which a light emitting portion 52 is disposed. It will be appreciated by those of skill in the art that the light emitting device 48 may be of any appropriate type, shape, or size, and the light emitting device 48 may be disposed in any appropriate manner relative to the base such that the line of light 58 from the light source projects onto a top surface of the sheet material 60 when the sheet material 60 to be cut is placed on the upper surface 14 of the base 12. It will also be appreciated by those of skill in the art that more than one light emitting device 48 could be used on a single trimmer 10. The light emitting device 48 is preferably a laser or other light source capable of projecting a relatively narrow line of light onto a sheet material 60. If the light emitting device 48 is a laser, a class I, II, or III laser, for example, may be suitable. The light emitting device 48 may be activated and deactivated, for example, by a switch, sensor, or other suitable device or method known in the art.

While the light emitting device 48 may be fixed relative the cutting edge 16, the light emitting device 48 is preferably adjustably mounted such that the user may adjust the line of projection of light from the device 48 in order to correct any misadjustment that may result from shipping, handling, or the like, or merely to accommodate user preferences. Those of skill in the art will appreciate that adjustment of the light emitting device 48 may take place by any appropriate arrangement, such as, for example, physical relocation of the light emitting device 48. For example, the light emitting device 48 may be laterally moved relative to an edge of the base 12, or may be raised or lowered relative to the upper surface 14 of the base 12.

In the illustrated embodiment, the light emitting device 48 is a laser and is provided with adjustment mechanisms that may be utilized to calibrate the device to ensure accurate alignment of the light line with the cutting edge 16 despite minor changes that may occur due to, for example, jostling during transport of the trimmer 10. As shown in FIGS. 6 and 7, adjustment mechanisms 54, 56 pivot the light emitting device 48 around respective axes to adjust the location of the projection of the line of light. Adjustment mechanism 54 pivots the light emitting device 48 around the X-axis to adjust the angular alignment of the line of light, i.e., the angle of the line of light relative to the cutting edge. In contrast, adjustment mechanism 56 pivots the light emitting device 48 around the Z-axis to move the line of light in a lateral direction, i.e., in a direction that is generally perpendicular to the cutting edge 16. In the illustrated embodiment, adjustment mechanism 56 is fixed to the light emitting device 48, although an alternate arrangement may be provided. In utilizing the term “move” when describing the use of the adjustment mechanisms 54, 56, it will be appreciated that the “moving” the line of light is being used to describe an alteration of the direction and/or manner in which the light directed. FIG. 8 shows the light emitting device 48 pivoted by the adjustment mechanism 56 to an alternate position than shown in the other figures.

The adjustment mechanisms 54, 56 can be utilized to calibrate the line of light relative to the cutting edge 16 generally as follows: Adjustment mechanism 56 is preferably first utilized to move the line of light in a lateral direction to such a location wherein the end of the line of light proximal to the light emitting device 48 is disposed just at the cutting edge 16. Adjustment mechanism 54 is then utilized to adjust the angle of the line of light to a position wherein it is disposed coincident with or parallel to the cutting edge 16. If necessary, adjustment mechanism 56 may then be utilized to further adjust the line of light in a lateral direction until such time as it is coincident with the cutting edge 16 to correct any remaining deviation. If a cover 46 is provided, the adjustment mechanism 54 may be accessible through opening 51, and adjustment mechanism 56 may be accessible through opening 49, for example.

Each of the forms of light emitting device adjustments described above, if provided, may be performed by a user to position and calibrate the light emitting device 48 as desired. Allowing the user to make adjustments to the light emitting device 48 enables a user to direct a line of light 58 emitted from the light emitting device 48 at a desired location. It also enables a user to correct any undesired movement of the light emitting device 48 during transportation or storage that may cause the line of light from the light emitting device 48 to project askew from a desired path. One of ordinary skill in the art would recognize that adjustment of the light emitting device may be performed by any suitable method known in the art.

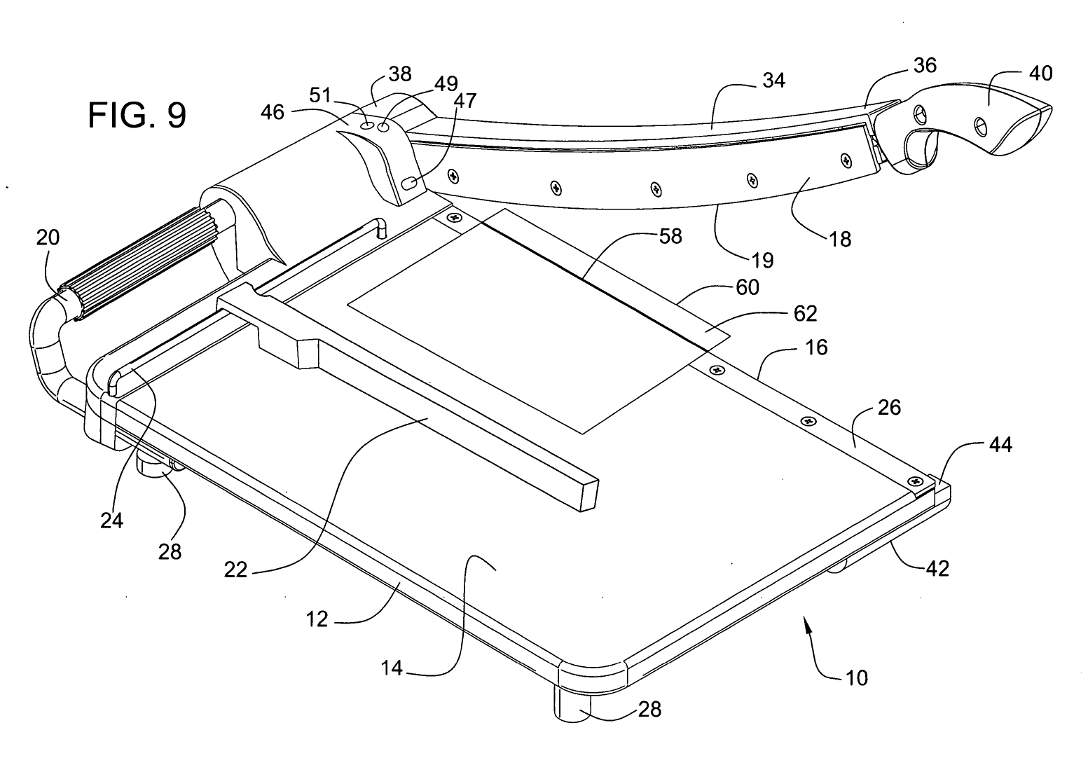

In use, the light emitting device 48 projects a line of light 58 onto the top surface 62 of a sheet material 60 to provide a visual indication of the location of the sheet material 60 relative to the cutting edge 16 of the upper surface 14 of the base 12. For example, as shown in FIG. 9, when a sheet material 60 is disposed above the upper surface 14 of the base 12 such that a portion of the sheet material 60 extends over the edge 16 of the base 12, at least a portion of the edge 16 is covered by the sheet material 60. When this occurs, it is difficult for the user to know exactly where the cut will be made on the sheet material 60. In accordance with the teachings of the invention, the light emitting device 48 may be arranged such that it projects a line of light 58 directly along the cutting edge 16 of the base 12. Therefore, when a sheet material 60 is placed on the upper surface 14 of the base 12 and at least a portion of the sheet material 60 extends over the edge 16, the line of light 58 provides a visual indication on the top surface 62 of the sheet material 60 at the precise location where the cut is to be made. Thus, the user knows exactly where the cut will be made along the entire piece of the sheet material 60.

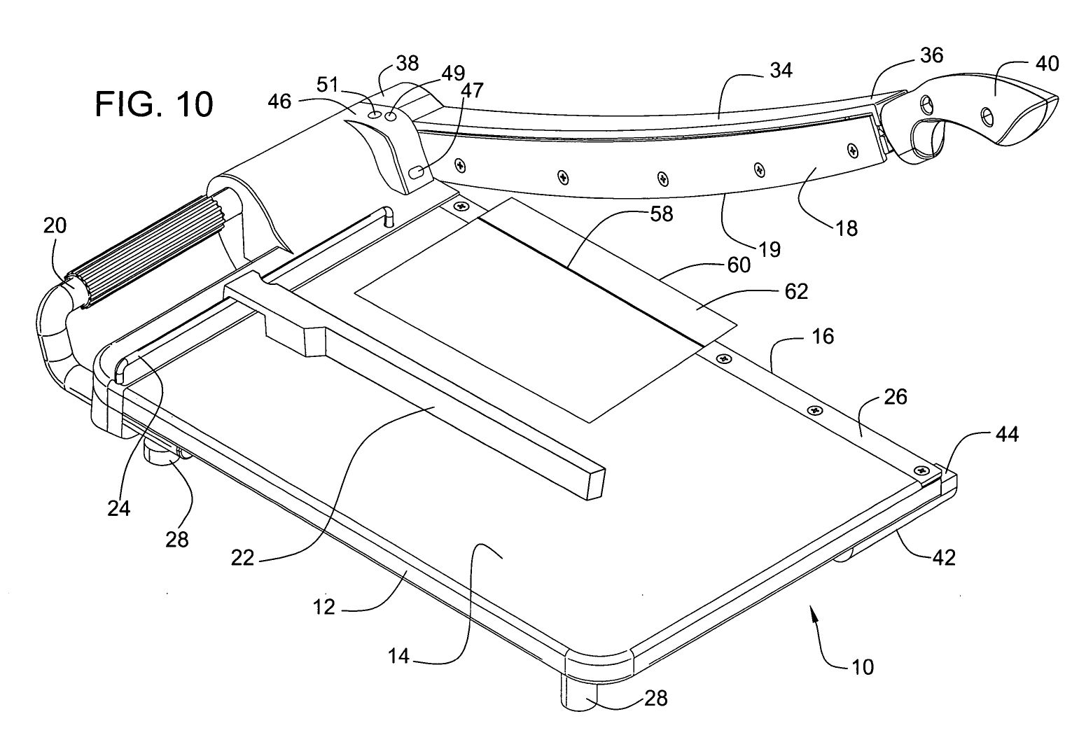

Furthermore, as shown in FIG. 10, the position of the line of light 58 need not be limited to the cutting edge 16. In accordance with the teachings of the invention, the light emitting device 48 may be adjusted to dispose a line of light 58 at a plurality of other desired positions along the top surface 62 of the sheet material 60 to provide a visual indication of the position of the sheet material 60 relative to the cutting edge 16. In this way, the trimmer 10 may provide for projection of the light line at set distances, or at any given location over a range. This enables a user, for example, to cut the sheet material 60 at a certain measured distance from some reference point on the sheet material 60.

By way of example and not limitation, the light emitting device 48 could be utilized to trim borders around photographs. Photographs are often provided with a portion containing the image and a border around the perimeter of the image. Often a user may want this border to be trimmed to a certain desired thickness. In accordance with the teachings of the invention, the user may arrange the line of light 58 to project a certain measured distance from the edge 16 of the base 12. The user can then line up the edge of the image with the line of light projected on the top surface of the picture, leaving any excess undesired border of the photograph to extend beyond the edge 16. This excess border can then be trimmed off by lowering the blade 18. With the assistance of the light emitting device 48, the user is confident that the border is trimmed to the desired thickness along the entire edge of the image. The sheet material 60 itself could be any suitable sheet material 60 of any suitable size and is not limited to photographs. The sheet material 60 may include, for example, paper, card stock, or sheets of plastic material such as may be utilized in the construction or binding of books.

Any references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context

What is claimed is:

1. A cutting apparatus for cutting sheet material, the sheet material comprising a top surface, comprising:
a base comprising an upper surface having an edge,
a non-circular cutting blade pivotably coupled to the base portion and movable between a first position wherein the blade is at least partially separate from the edge to a second position wherein the blade is disposed at least partially adjacent to the edge, the blade being movable from the first position to the second position to cut the sheet material disposed at least partially on the upper surface and extending at least partially off of the upper surface along the edge, and
a light emitting device disposed above the base portion to project a line of light onto the top surface of the sheet material disposed at least partially on the upper surface and extending at least partially off of the upper surface along the edge,
such that when the sheet material is placed on the upper surface of the base, the light emitting device projects the line of light onto the top surface of the sheet material to provide a visual indication of the location of the sheet material relative to the edge prior to cutting the sheet material with the blade.

2. The cutting apparatus of claim 1 further comprising a cover for at least partially containing the light emitting device.

3. The cutting apparatus of claim 1 wherein the light emitting device is a laser.

4. The cutting apparatus of claim 1 wherein the light emitting device is adjustable to project light to one of a plurality of positions along the base.

5. The cutting apparatus of claim 4 wherein the light emitting device is adjustable by at least one of rotating, pivoting, and laterally moving the light emitting device.

6. The cutting apparatus of claim 1 further comprising a plate attached to the base and disposed near the cutting edge.

7. The cutting apparatus of claim 1 further comprising a crossbar.

8. The cutting apparatus of claim 1 further comprising a safety shield.

9. A cutting apparatus for cutting sheet material, the sheet material comprising a top surface, comprising:
a base comprising an upper surface having an edge,
an elongate cutting blade pivotably coupled to the base portion and movable between a first position wherein the blade is at least partially separate from the edge to a second position wherein the blade is disposed at least partially adjacent to the edge, the blade being movable from the first position to the second position to cut the sheet material disposed at least partially on the upper surface and extending at least partially off of the upper surface along the edge, and
a light emitting device disposed above the base portion to project a line of light onto the top surface of the sheet material disposed at least partially on the upper surface and extending at least partially off of the upper surface along the edge,
such that when the sheet material is placed on the upper surface of the base, the light emitting device projects the line of light onto the top surface of the sheet material to provide a visual indication of the location of the sheet material relative to the edge prior to cutting the sheet material with the blade.

10. The cutting apparatus of claim 9 wherein the elongate cutting blade comprises an arcuate blade edge.

11. The cutting apparatus of claim 9 wherein the light emitting device is adjustable to project light to one of a plurality of positions along the base.

12. The cutting apparatus of claim 11 wherein the light emitting device is adjustable by at least one of rotating, pivoting, and laterally moving the light emitting device.

13. The cutting apparatus of claim 9 wherein the light emitting device is a laser.

14. The cutting apparatus of claim 9 further comprising a crossbar.

15. The cutting apparatus of claim 9 further comprising a safety shield.

16. A method of cutting sheet material comprising:
providing a cutting apparatus comprising a base and a non-circular cutting blade pivotably coupled to the base, the base comprising an upper surface having an edge,
disposing the sheet material on the upper surface of the base with at least a portion of the sheet material extending beyond the edge,
projecting a line of light onto a top surface of the sheet material to provide a visual indication of the location of the sheet material relative to the edge, and
pivoting the blade toward the edge to cut the sheet material.

17. The method of claim 16 further comprising moving the line of light to a desired position relative to the cutting edge.

18. The method of claim 16 further comprising activating a light emitting device to project the line of light.

19. The method of claim 18 further comprising adjusting the light emitting device by at least one of rotating, pivoting, and laterally moving the light emitting device.

20. The method of claim 16 wherein the blade is an elongate member.
